(19) United States
(12) Patent Application Publication
(10) Pub. No.: US 2004/0206438 A1
(43) Pub. Date: Oct. 21, 2004

(54) Pneumatic tire with puncture prevention layer in tire inner surface

(76) Inventors: Hidekazu Takeyama, Hiratsuka-shi (JP); Hidekazu Onoi, Hiratsuka-shi (JP); Akio Ogata, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/841,561

(22) Filed: May 10, 2004

Related U.S. Application Data
(62) Division of application No. 09/924,966, filed on Aug. 9, 2001, now abandoned.

(30) Foreign Application Priority Data
Aug. 9, 2000 (JP) 2000-240806
Jun. 11, 2001 (JP) 2001-175301

(51) Int. Cl. B60C 19/12; B29C 73/22

(52) U.S. Cl. 152/504; 523/166

(57) ABSTRACT

A pneumatic tire is disclosed, which comprises a bubble-containing adhesive composition layer as a puncture prevention layer or a puncture prevention layer formed by covering at least one surface of a sheet-like foamed body with a nonporous adhesive composition layer, disposed in the inner surface of a tire main body. This pneumatic tire having the puncture prevention layer in the tire inner surface is adapted to reduce the weight of the tire.

### BACKGROUND OF THE INVENTION

1. Field of the Invention

The present invention relates to a pneumatic tire. More specifically, the invention relates to a pneumatic tire having a puncture prevention layer in a tire inner surface, and capable of reducing the weight of the tire.

2. Description of the Related Art

Heretofore, in order to prevent puncture caused by the stepping of a tire on a nail or the like during traveling, there has been known a pneumatic tire adapted to prevent puncture by disposing a puncture prevention layer made of an adhesive composition in the inner surface of a tire main body, and causing the adhesive composition to adhere to the nail or the like suck into the tire to cover the suck part, thereby suppressing the leakage of air (e.g., Japanese patent application Kokai publication No. 54-6206, Japanese patent application Kokai publication No. 55-11998, Japanese patent application Kokai publication No. 6-270283, and so on).

However, the disposition of the puncture prevention layer made of the adhesive composition in the tire inner surface brings about a considerable increase in a tire weight (e.g., an increase of about 1 kg). Consequently, the great increase of fuel economy for an automobile may set back energy conservation, and the increase of exhaust gas may create a global environmental problem.

### SUMMARY OF THE INVENTION

It is an object of the present invention to provide a pneumatic tire comprising a puncture prevention layer in a tire inner surface, and capable of reducing the weight of the tire.

In accordance with the invention, a pneumatic tire is provided, comprising:

a bubble-containing adhesive composition layer disposed as a puncture prevention layer in a tire inner surface.

In accordance with the invention, a pneumatic tire is provided, comprising: a puncture prevention layer formed by covering at least one surface of a sheet-like foamed body with a nonporous adhesive composition layer. In this case, the puncture prevention layer is stuck to an area corresponding to at least a tread portion of the tire inner surface such that the foamed body can be set inside the adhesive composition layer.

As described above, the bubble-containing adhesive composition is used for the puncture prevention layer disposed in the tire inner surface. Alternatively, the puncture prevention layer is used, which is formed by covering at least one surface of the sheet-like foamed body with the nonporous adhesive composition layer. Therefore, it is possible to provide a pneumatic tire capable of reducing a tire weight more greatly than in the conventional case, and having a sufficient puncture prevention function even with the light weight.

### BRIEF DESCRIPTION OF THE DRAWINGS

FIG. 1 is a meridian half sectional view showing an example of a pneumatic tire of the present invention.

FIG. 2 is a view illustrating a mode of pulling out a nail stuck into the pneumatic tire of FIG. 1.

FIG. 3 is a view showing a structure of a sponge-like foamed body of a coating-removed type.

FIG. 4 is a sectional view showing an example of a puncture prevention layer of the pneumatic tire of the invention.

FIG. 5 is a meridian half sectional view showing another example of a pneumatic tire of the invention.

FIG. 6 is a view illustrating a mode of pulling out a nail stuck into the pneumatic tire of FIG. 5.

FIG. 7 is a meridian half sectional view showing a conventional pneumatic tire having a puncture prevention layer stuck thereto.

### DETAILED DESCRIPTION OF THE INVENTION

Next, the constitution of the present invention will be described with reference to the accompanying drawings.

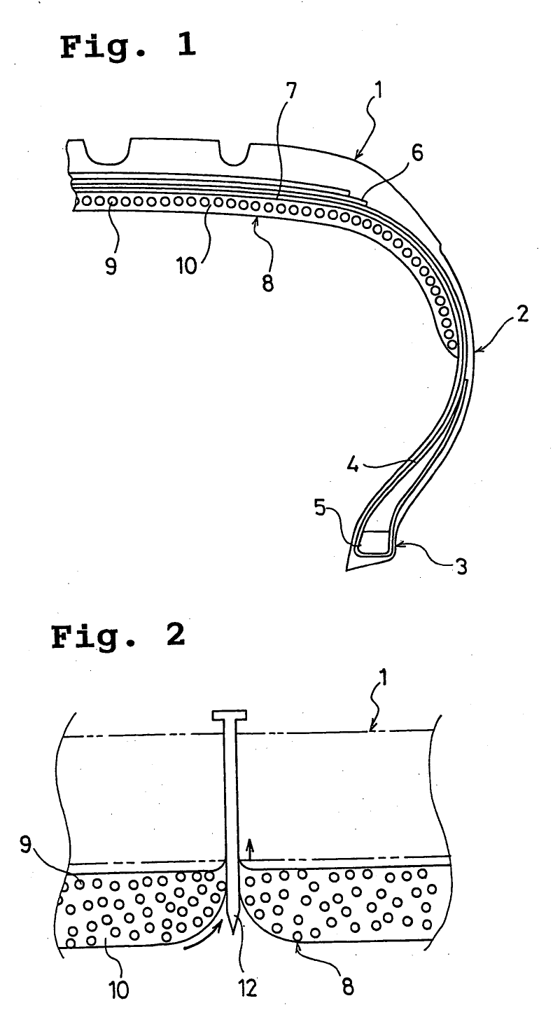

FIG. 1 is a meridian half sectional view showing an example of the pneumatic tire of the invention.

A reference numeral 1 denotes a tread portion; 2 a side wall portion: and 3 a bead portion.

Inside the tire, Carcass layer 4 is provided between a pair of left and right bead cores 5 and 5. In addition, a belt layer 6 is provided in the outer periphery of the Carcass layer 4 in the tread portion 1.

In the tire inner surface 7, a puncture prevention layer 8 made of an adhesive composition 10 containing bubbles 9 is stuck from an area corresponding to the tread portion 1 to the tire maximum width part of the side wall portion 2.

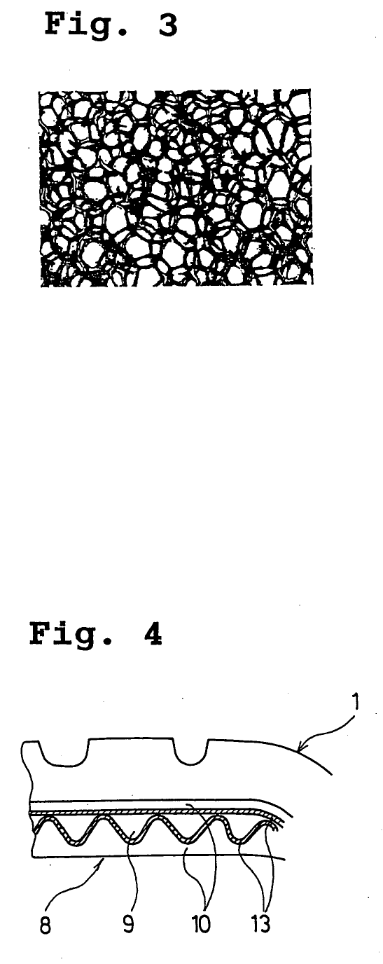

When the pneumatic tire thus constructed steps on a nail during traveling and, as shown in FIG. 2, if a nail 12 penetrates the tread portion 1, and the puncture prevention layer 8, reaching the tire inner side, the adhesive composition layer containing the bubbles 9, in the surface side of the puncture prevention layer 8, tightly adheres to the nail 12 for sealing. Thus, the leakage of air can be prevented. In addition, when the nail 12 is pulled out, the adhesive composition layer is pulled into the through-hole of the tread portion 1 as the nail 12 is pulled out. Thus, the leakage of air can be prevented.

As described above, the adhesive composition layer is formed to contain the bubbles 9. The inclusion of the bubbles 9 can greatly reduce the weight of the puncture prevention layer 8. In the conventional pneumatic tire having a puncture prevention layer stuck thereto, shown in FIG. 7, a tire weight cannot be reduced because the puncture prevention layer is made of only an adhesive composition.

The bubbles of the invention may be a foamed body impregnated with an adhesive composition, hollow body particles and/or foamed body particles, bubbles by foaming or the like. The bubbles may be independent or continuous.

Specific embodiments to be taken are as follows:

A. Adhesive composition layer made of a foamed body impregnated with an adhesive composition.

B. Adhesive composition layer containing hollow particles and/or foamed body particles.

C. Adhesive composition layer containing foamed bubbles.

A foamed body impregnated with an adhesive composition can be obtained by impregnating a sponge-like urethane continuous bubble foamed body made of a resin such as polyurethane, nylon or the like, or one of coating-removed type formed in a net shape like that shown in FIG. 3, (so-called reticulated foam), with an adhesive composition. For example, one impregnated with an adhesive composition while leaving gaps in a foamed body may be disposed in a tire inner surface. Alternatively, an adhesive composition is coated on the tire inner surface, then a foamed body is disposed thereon, and the adhesive composition is dipped therefrom.

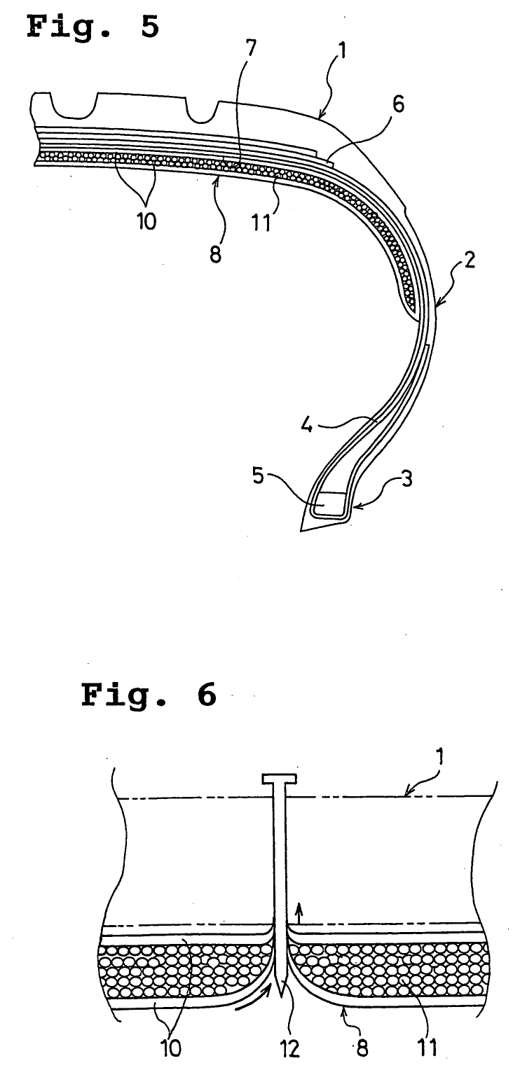

An another example of a foamed body impregnated with an adhesive composition, one like that denoted by a reference numeral 9 in FIG. 4 can be used, which is formed by coating/dipping an adhesive composition 1 in both surfaces of a foamed body made of a bubble-containing resin sheet including two sheets 13 laminated such that bubbles can be scattered about.

Apparently, since the use of the foamed body impregnated with the adhesive composition for the bubble-containing adhesive composition layer suppresses the fluidity of the adhesive composition, when the puncture prevention layer 8 is disposed even in the tire side portion as shown in FIG. 1, it is possible to suppress the flowing of the adhesive composition by a force applied during tire traveling.

For the adhesive composition containing hollow particles and/or foamed body particles, one can be used, which is prepared by blending hollow body particles or foamed body particles containing bubbles inside in the adhesive composition, and dispersing the particles. Hollow particles or foamed body particles may be formed by blending particles foamed beforehand to be made hollow or foamed in the adhesive composition, or blending foamed particles containing foaming agents in the adhesive composition and forming the particles in the adhesive composition by heating or the like.

Further, a foamed adhesive composition can be obtained by blending foaming agents in the adhesive composition, and foaming the foaming agents by heating or the like.

The volume or size of bubbles in the bubble-containing adhesive composition layer of the invention can be properly set according to required tire weight reduction or puncture prevention performance. Thus, there are no particular limitations in this regard. However, porosity should preferably be set in the range of 30 to 97%, more preferably in the range of 50 to 97%, in order to enhance tire weight reduction and puncture prevention performance.

For the adhesive composition, there are no particular limitations on materials, and any can be used as long as it has adhesion, and adheres to a nail or the like stuck into the tire to prevent the leakage of air. For example, an adhesive composition containing elastomer can be suitably used.

Regarding elastomer, a preferred composition should contain at least one selected from the group consisting of butyl rubber, polyisobutylene, natural rubber, isoprene rubber, polybutene, and two or more kinds of elastomer may be blended as occasion demands.

Further, to obtain adhesion, low molecular oligomer such as amorphous polyolefin, paraffin oil, liquid polybutene or the like, or tackifier such as a petroleum resin may be added. To obtain heat resistance, proper crosslinking agents or curing agents may be blended. For example, in the case of butyl rubber or polybutene, p-quinone dioxime or the like may be blended.

According to the invention, the following modes are advantageous as other means for reducing the weight of the puncture prevention layer by using the adhesive composition and the foamed body.

That is, a pneumatic tire is provided, comprising a puncture prevention layer formed by covering at least one surface of a sheet-like foamed body with a nonporous adhesive composition layer. In this case, the puncture prevention layer is stuck to an area corresponding to at least the tread portion of a tire inner surface such that the foamed body can be set inside the adhesive composition layer.

Now, the constitution of this pneumatic tire will be described by referring to the drawings.

FIG. 5 is a meridian half sectional view showing another example of a pneumatic tire of the invention.

A puncture prevention layer 8 is formed by sticking a nonporous adhesive composition 10 to both inner and outer surfaces of a sheet-like foamed body 11, and stuck to a tire inner surface 7 through a layer made of the adhesive composition 10 inside.

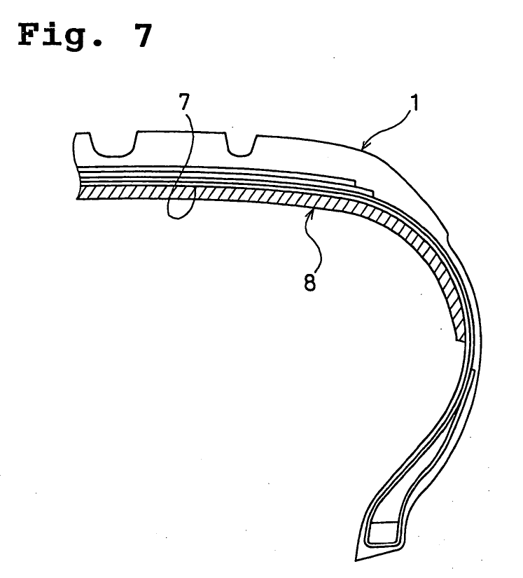

When the pneumatic tire thus constructed steps on a nail during traveling and, as shown in FIG. 6, if a nail 12 penetrates a tread portion 1, and the puncture prevention layer 8, reaching the tire inner side, the adhesive composition 10 in the surface side of the puncture prevention layer 8 tightly adheres to the nail 12. Thus, the leakage of air can be prevented. In addition, when the nail 12 is pulled out, the layer made of the adhesive composition 10 is pulled into the through-hole of the tread portion 1 for sealing as the nail 12 is pulled out. Thus, the leakage of air can be prevented.

According to the invention, the puncture prevention layer is composed of the sheet-like foamed body and the adhesive composition layer covering the surface thereof. Such a composite constitution with the foamed body replaces a part of the heavy adhesive composition by the light foamed body, making it possible to reduce the weight of the entire tire. Moreover, when compared with a punctuation prevention layer comprising the adhesive composition alone, the adhesive composition layer can undergo a larger extent of deformation, so that the adhesive composition can more easily move into the through-hole.

The adhesive composition layer needs only to be formed in at least one surface of the sheet-like foamed body, and positioned in the surface layer side thereof with the foamed body set inside when the puncture prevention layer is stuck to the tire inner surface.

Preferably, as in the example of FIG. 5, the adhesive composition layer should be provided in both surfaces of the foamed body.

When the adhesive composition layer is disposed in both surfaces of the sheet-like foamed body, the adhesive composition layer in the tire inner surface also serves as adhesive. However, if the adhesive composition layer is provided only in the surface layer side, proper adhesive is used. For example, an adhesive agent such as rubber cement, or denatured urethane containing adhesive can be used.

There are no particular limitations on a thickness of the adhesive composition layer. A minimum thickness may be set, capable of maintaining sealing when the tire steps on a nail or the like. For example, a thickness should preferably be set in the range of 0.5 mm to 3.0 mm, more preferably in the range of 1.0 mm to 2.0 mm.

There are no particular limitations on a forming method of the adhesive composition layer. For example, a film-like adhesive composition may be stuck, or sprayed. Preferably, spraying should be used.

If spraying is used, compared with the processing of the sheet-like adhesive composition, processing is easier, simplifying a manufacturing process.

For the foamed body of the puncture prevention layer, a sheet-like foamed body having continuous or independent bubbles, a foamed body containing hollow body particles and/or foamed body particles collected in a sheet form, or the like can be used. The hollow body particles or foamed body particles made hollow or foamed by being subjected to foaming beforehand. As a method for forming these particles in a sheet-like aggregate, the particles can be held between two sheets, and then the sheets can be laminated.

The bubbles of the foamed body may be continuous or independent. However, continuous bubbles are preferable. When a stuck nail is pulled out, if the foamed body has continuous bubbles, the foamed body can be easily deformed greatly with the adhesive composition, making it possible to increase the volume of securing an adhesive composition.

For the foamed body of the invention, preferably, the number of cells defined by JIS K6400 should preferably be set in the range of 10 to 40/25 mm. If the number of cells is less than 10/25 mm, the number of bubbles may be too small or bubbles may be too large. If the number of bubbles is too small, an unfavorable state is set, where the foamed body becomes heavy and hard. If the bubbles are too large, an unfavorable state is set, where the foamed body becomes soft, and the holding of the adhesive composition layer becomes difficult. If the number cells exceeds 40/25 mm, a number of very small bubbles are created, limiting weight reduction.

The number of cells defined by JIS K6400 takes a value, obtained by counting the number of cells present on the straight line of 10 mm in the surface of the foamed body, and multiplying it by 2.5.

A thickness of the foamed body may be decided so as to be balanced with a thickness of the adhesive composition. Preferably, a thickness thereof should be set in the range of 2.5 mm to 25 mm, more preferably in the range of 5 mm to 15 mm.

Regarding a material for the foamed body, polyurethane foam, polystyrene foam, rubber bubbles, polyvinyldene chloride bubbles, polyester bubbles or the like can be used. Preferably, the polyurethane foam should be used.

As occasion demands, the foamed body may be disposed more outside than the adhesive composition layer of the surface layer covering the inner side foamed body. Accordingly, since a surface exposed in the tire inner side becomes a foamed body, direct contact with the adhesive composition layer is prevented, improving the workability of attaching/removing the tire.

The invention should not be limited to the illustrated pneumatic radial tire, but it can be similarly applied to a pneumatic bias tire.

Thus, according to the pneumatic tire of the invention, since the puncture prevention layer stuck to the tire inner surface is formed by covering the sheet-like foamed body with the adhesive composition layer, it is possible to reduce the tire weight more greatly than the conventional tire by replacing a part of heavy adhesive composition layer by a light foamed body.

Next, the invention will be described based on the embodiments.

Various puncture prevention layers described below were disposed, as shown in FIG. 1, in the inner surface of a cured automobile pneumatic tire having a tire size 205/65R15, and a tire weight was measured. Then, a nail was stuck into the tire, pulled out and, after 24-hour leaving, a reduction in the air pressure of the tire was measured, and puncture prevention performance was verified.

For the adhesive composition of each puncture prevention layer, the mixture of blending (weight part) shown in Table 1 below was used.

TABLE 1

| | |
|---|---|
| Butyl rubber | 100 wt. pts. |
| Paraffin oil | 20 wt. pts. |
| Liquid polybudene | 200 wt. pts. |
| Oil resin | 30 wt. pts. |
| Carbon black | 15 wt. pts. |
| Zinc white | 3 wt. pts. |
| Stearic acid | 1 wt. pts. |
| P-quinone dioxime | 6 wt. pts. |
| Curing accelerator DM | 4 wt. pts. |
| Minium (Pb₃O₄) | 2 wt. pts. |

For each component shown in Table 1, the following was used:

Butyl rubber: Exxon Butyl 258, by Exxon Inc.

Liquid polybudene: Nisseki Polybudene HV 100, by Nihon Sekiyu Inc.

Oil resin: Hulets G-100 X, by Mitsui Kagaku Inc.

Carbon black: Shoblack B 339, by Showa Cabot Inc.

Curing accelerator DM: Dibenzothiazyldisulfide

### Embodiment 1 and Comparison Example 1

The tire of the embodiment 1 was obtained by disposing, as an adhesive composition, one impregnated with the adhesive composition of Table 1 in the continuous bubble urethane foamed body sheet of a coating-removed type in a tire inner surface, and heating and curing the adhesive composition at 150° C. for 30 min., to form a bubble-containing adhesive composition layer (puncture prevention layer 8) having a thickness of 10 mm, and porosity of 80%. For comparison, the tire of the comparison example 1 was obtained by disposing only an adhesive composition in the tire inner surface and, as in the case of the embodiment 1, heating the adhesive composition to form an adhesive composition layer having a thickness of 10 mm.

In the embodiment 1, compared with the comparison example 1, the weight of the puncture preventing layer 8 was reduced by 50%, and puncture prevention performance when nail sticking occurred exhibited a good result similarly to the comparison example.

### Embodiment 2 and Comparison Example 2

The tire of the embodiment 2 was obtained by disposing, as an adhesive composition, one prepared by blending fine particles of a vinyl chloride resin (Microsphere F-82, by Matsumoto Yushi Inc.) containing the foamed body of 20 wt. pts., of Table 1, in a tire inner surface, heating and curing the adhesive compound at 150° C. for 30 min., to form hollow fine particles, and forming a bubble-containing adhesive compound layer (puncture prevention layer 8) having a thickness of 3 mm, and porosity of 40%. For comparison, the tire of the comparison example 2 was manufactured by disposing only an adhesive compound in a tire inner surface and, as in the case of the embodiment 2, heating it to form an adhesive compound layer having a thickness 3 mm.

In the embodiment 2, compared with the comparison example 2, the weight of the puncture prevention layer 8 was reduced by 30%, and puncture prevention performance when nail sticking occurred exhibited a good result similarly to the comparison example 2.

### Embodiment 3

The tire of the embodiment 3 was obtained by disposing, as an adhesive compound, one prepared by blending foamed polystyrene particles (Styropolem, by Mitsubishi Kagaku Inc.) of 30 wt. pts., in a composition 100 wt. pts., heated and cured at 150° C. for 30 min., of Table 1, in a tire inner surface, and then forming a bubble-containing adhesive compound layer (puncture prevention layer 8) having a thickness of 3 mm, and porosity of 70%.

In the embodiment 3, compared with the comparison example 2, the weight of the puncture prevention layer 8 was reduced by 45%, and puncture prevention performance when nail sticking occurred exhibited a good result similarly to the comparison example 2.

### Embodiment 4

The tire of the embodiment 4 was obtained by coating, as an adhesive compound, one heated and cured at 150° C. for 30 min., having blending shown in Table 1, on a tire inner surface to have a thickness of 0.5 mm, disposing a bubble-containing resin sheet made of a polyethylene resin like that denoted by a reference numeral 5 of FIG. 4 thereon, coating an adhesive compound thereon, and accordingly forming a bubble-containing adhesive compound layer (puncture prevention layer 8) having a thickness of 10 mm, and porosity of 80%.

In the embodiment 4, compared with the comparison example 1, the weight of the puncture prevention layer 8 was reduced by 50%, and puncture prevention performance when nail sticking occurred exhibited a good result similarly to the comparison example 1.

### Embodiment 5

A sheet was obtained by cutting a coating-removed type polyurethane foam (made by Kurabo Industries, Ltd.), which had a cell number of 15 and was specified in JIS K 6400, in thickness of 10 mm.

On both surfaces of the sheet, the adhesive composition blended as shown in Table 1 was spirally ejected at 150° C. by use of a high-pressure spray ejecting apparatus (made by Nordson Corporation), thus forming an adhesive coating layer having a thickness of 1.0 mm. The adhesive composition is cured during ejection. A tire of an embodiment 5 was obtained by disposing the member thus obtained on the inner surface of the tire.

In the embodiment 5, compared with the comparison example 1, the weight of the tire was reduced by 50%, and the puncture prevention performance when a nail sticking occurred exhibited a good result similarly to the comparison example 1.

1. A pneumatic tire comprising:
an adhesive composition layer fabricated from a foamed adhesive composition containing a plurality of voids and disposed as a puncture prevention layer in a tire inner surface.

2. (canceled).

3. A pneumatic tire according to claim 1, wherein said bubble-containing adhesive composition layer is made of an adhesive composition containing hollow body particles and/or foamed body particles.

4. A pneumatic tire according to claim 1, wherein said bubble-containing adhesive composition layer is made of a foamed adhesive composition.

5. A pneumatic tire according to any one of claims 1, 3 or 4, wherein porosity of said bubble-containing adhesive composition layer is set in a range of 30 to 97%.

6. A pneumatic tire comprising:
a puncture prevention layer formed by covering at least one surface of a sheet-like foamed body with a nonporous adhesive composition layer,
wherein said puncture prevention layer is stuck to an area corresponding to at least a tread portion of a tire inner surface in a manner of setting the foamed body inside the adhesive composition layer.

7. A pneumatic tire according to claim 6, wherein both surfaces of the sheet-like foamed body are covered with the adhesive composition layer.

8. A pneumatic tire according to one of claims 6 and 7, wherein the adhesive composition layer is formed by spraying.

9. A pneumatic tire according to any one of claims 6 to 8, wherein the sheet-like foamed body is made of polyurethane foam having the number of cells set in a range of 10 to 40/25 mm.

10. A pneumatic tire according to any one of claims 1 and 3 to 9, wherein the adhesive composition layer contains elastomer.

11. A pneumatic tire according to claim 10, wherein the elastomer is one selected from the group consisting of butyl rubber, polyisobutylene, natural rubber, isoprene rubber, and polybutene.

12. A pneumatic tire according to claim 1, wherein each one of the plurality of voids contains air.

13. A pneumatic tire according to claim 1, wherein the plurality of voids are contained in at least one resin sheet.

14. A pneumatic tire according to claim 13, wherein the at least one resin sheet is a continuous urethane foamed body sheet.

15. A pneumatic tire according to claim 1, wherein the adhesive composition layer has a porosity in an approximate range of 30% and 97%.

16. A pneumatic tire according to claim 1, wherein the adhesive composition contains at least one elastomer selected from a group consisting of butyl rubber, polyisobutylene, natural rubber, isoprene rubber and polybutene.

17. A pneumatic tire according to claim 16, wherein the adhesive composition contains a low molecular oligomer including at least one of an amorphous polyolefin, paraffin oil, liquid polybutene and petroleum resin.

18. A pneumatic tire according to claim 17, wherein the adhesive composition contains an adhesive agent including at least one of rubber cement and denatured urethane.

19. A pneumatic tire according to claim 1, wherein the adhesive composition layer has a thickness in an approximate range of 0.5 mm and 3.0 mm.
